(19) United States
(12) Patent Application Publication
(10) Pub. No.: US 2011/0163229 A1
(43) Pub. Date: Jul. 7, 2011

(54) HIGH THROUGHPUT SEM TOOL

(75) Inventors: Juergen Frosien, Riemerling (DE); Helmut Banzhof, Poing (DE); Pavel Adamec, Haar (DE)

(73) Assignee: APPLIED MATERIALS ISRAEL, LTD., Rehovot (IL)

(21) Appl. No.: 12/528,306

(22) PCT Filed: Feb. 22, 2008
(86) PCT No.: PCT/EP2008/001414

§ 371 Date: Dec. 8, 2009

Related U.S. Application Data
(60) Provisional application No. 60/891,185, filed on Feb. 22, 2007.
(60) Provisional application No. 61/014,702, filed on Dec. 18, 2007.

(51) Int. Cl. G01N 23/225; G01N 23/227; G01N 23/22; G01N 23/203; H01J 1/50

(52) U.S. Cl. 250/310; 250/396 ML

(57) ABSTRACT

A scanning charged particle beam device (100) is described. The scanning charged particle beam device includes a beam emitter (102) for emitting a primary electron beam, a first scan stage for scanning the beam over a specimen, an achromatic beam separator (130) adapted for separating a signal electron beam from the primary electron beam, and a detection unit (172,174,178) for detecting signal electrons.

### FIELD OF THE INVENTION

The present invention relates to a beam electron microscope, in particular a high throughput tool for the semiconductor industry. Specifically it relates to a beam scanning charged particle beam device, a method of operating a beam scanning charged particle beam device, and uses of a beam scanning charged particle beam device.

### BACKGROUND OF THE INVENTION

A modern semiconductor device is component of approximately 20-30 pattern layers that collectively implement the intended functionality of the designer. In general, the designer describes the chip functionality with high level, behavior design languages like VHDL, and then a series of EDA tools translate the high-level description into a GDSII file. The GDSII file contains a geometrical description of polygons and other shapes that describe the patterns of the different layers. The GDSII file accompanied with process design rules for the fabrication process to be used to make the device describes the intended geometry on the layout with the relevant tolerances.

Modern photolithography presents several challenges, including those associated with moving from 90 nm to 45 nm and 32 nm while keeping the stepper wavelengths at 193 nm. This requires further transformation of the intended layout geometry to a post resolution enhancement technique (RET) version of the GDSII file. The new GDSII file includes pattern modifications for optical proximity corrections (OPC) and mask technology. The complex set of OPC corrections, mask making and stepper conditions is required to print the intended geometry on the wafer.

In light of the above, semiconductor technologies have created a high demand for structuring and probing specimens within the nanometer scale. Micrometer and nanometer scale process control, inspection or structuring, is often done with charged particle beams. Probing or structuring is often performed with charged particle beams which are generated and focused in charged particle beam devices. Examples of charged particle beam devices are electron microscopes, electron beam pattern generators, ion microscopes as well as ion beam pattern generators. Charged particle beams, in particular electron beams, offer superior spatial resolution compared to photon beams, due to their short wavelengths at comparable particle energy.

For semiconductor manufacturing, throughput can be a significant limitation in tools for scanning a geometry in its entirety. Assuming a CD-SEM resolution of 1 nm, a 10 mm² die contains 10E14 pixels. Accordingly, for covering the entire layout, a fast inspection architecture is desired.

Electron beam systems for high throughput might be for example systems with multiple electron beams, which may be used for a fast wafer inspection, and are generally realized by either an array of conventional single beam columns having a spacing in the range of a few centimeters or by a single column with an array of beams. In the latter case, the beam array has relatively small electron beam spacing in a range of 10 μm-100 μm. Thereby, a high number such as hundreds or even thousands of beams can be used. However, individual corrections of the beams are difficult.

In order to provide a tool that utilizes electron beam optics to scan the entire geometry of the chip layer within resolution and desired signal to noise ratio (SNR), which enables extraction and verification of the wafer pattern geometry against the design-intended GDSII file, i.e. the original GDSII file, improved and different system designs have to be considered.

### SUMMARY

In light of the above, a charged scanning particle beam device according to independent claim 1, a method of operating an achromatic beam deflector for charged particle beams according to independent claim 15 are provided.

According to one embodiment, a scanning charged particle beam device is provided. The device includes a beam emitter for emitting a primary electron beam, a first scan stage for scanning the beam over a specimen, an achromatic beam separator adapted for separating a signal electron beam from the primary electron beam, and a detection unit for detecting signal electrons.

Further advantages, features, aspects and details that can be combined with embodiments described herein are evident from the depending claims, the description and the drawings.

According to another embodiment, a method of operating an achromatic beam deflector for charged particle beams, the achromatic beam deflector having an optical axis is provided. The method includes providing a deflecting electrostatic dipole field, providing a deflecting magnetic dipole field, superimposing a quadrupole field to the magnetic dipole field and the electrostatic dipole field, wherein the electrostatic dipole field and the magnetic dipole field are adjusted with respect to each other to provide an achromatic beam deflection, and wherein the quadrupole field is adjusted to correct for a beam tilt of off-axis charged particle beams.

Embodiments are also directed to apparatuses for carrying out the disclosed methods and including apparatus parts for performing each described method step. These method steps may be performed by way of hardware components, a computer programmed by appropriate software, by any combination of the two or in any other manner. Furthermore, embodiments according to the invention are also directed to methods by which the described apparatus operates. It includes method steps for carrying out every function of the apparatus.

### BRIEF DESCRIPTION OF THE DRAWINGS

So that the manner in which the above recited features of the present invention can be understood in detail, a more particular description of the invention, briefly summarized above, may be had by reference to embodiments. The accompanying drawings relate to embodiments of the invention and are described in the following:

FIG. 1 shows a schematic view of a high throughput scanning electron beam device according to embodiments described herein;

FIG. 2A shows a schematic view of an achromatic beam separator for beam scanning electron beam devices according to embodiments described herein;

FIG. 2B shows another schematic view of an achromatic beam separator for beam scanning electron beam devices according to embodiments described herein;

FIG. 2C shows a schematic enlarged view of an achromatic beam separator and an off-axis correction thereof according to embodiments described herein;

FIG. 2D shows a schematic enlarged view of an achromatic beam separator and a further off-axis correction thereof according to embodiments described herein;

FIGS. 3A to 3E show results of model simulations for an achromatic beam separator according to embodiments described herein;

FIG. 4 shows a schematic view of a detection scheme for scanning electron beam devices according to embodiments described herein; and

FIG. 5 shows a schematic view of a further high throughput scanning electron beam device according to embodiments described herein.

### DETAILED DESCRIPTION OF THE INVENTION

Reference will now be made in detail to the various embodiments of the invention, one or more examples of which are illustrated in the figures. Each example is provided by way of explanation of the invention and is not meant as a limitation of the invention. For example, features illustrated or described as part of one embodiment can be used on or in conjunction with other embodiments to yield yet a further embodiment. It is intended that the present invention includes such modifications and variations.

Without limiting the scope of protection of the present application, in the following the charged particle beam device or components thereof will exemplarily be referred to as a charged particle beam device including the detection of secondary electrons. The present invention can still be applied for apparatuses and components detecting corpuscles such as secondary and/or backscattered charged particles in the form of electrons or ions, photons, X-rays or other signals in order to obtain a specimen image.

Generally, when referring to corpuscles it is to be understood as a light signal, in which the corpuscles are photons, as well as particles, in which the corpuscles are ions, atoms, electrons or other particles.

Within the following description of the drawings, the same reference numbers refer to the same components. Generally, only the differences with respect to the individual embodiments are described.

A “specimen” as referred to herein, includes, but is not limited to, semiconductor wafers, semiconductor workpieces, and other workpieces such as memory disks and the like. Embodiments of the invention may be applied to any workpiece on which material is deposited, which is inspected or which is structured. A specimen includes a surface to be structured or on which layers are deposited, an edge, and typically a bevel.

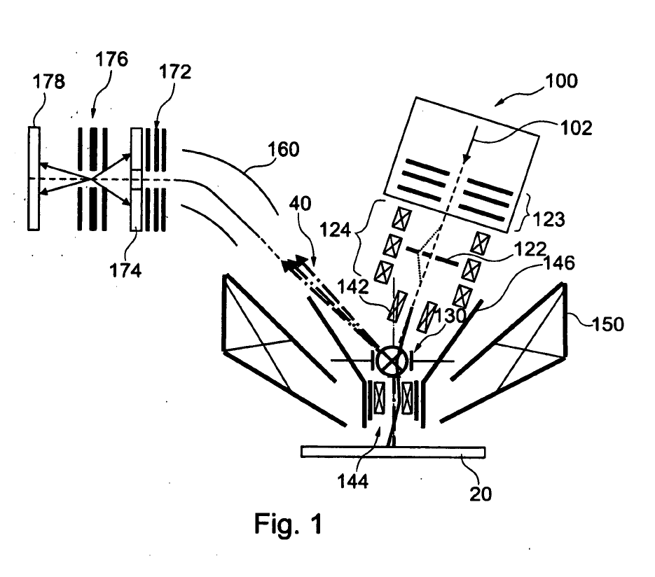

The scanning electron microscope includes a beam emitter. As sown in FIG. 1, the beam emitter with the emitter tip 102 emits an electron beam. The scanning electron beam device 100 includes a condenser lens 123 within the gun condenser area. The emitter tip 102 in the beam emitter can for example be a cold field emitter.

According to some embodiments described herein, the beam travels through an electron optical module 122/124 after being emitted from the emitter. This optical module provides an aperture plate with one or more apertures, e.g. of different size, for shaping the electron beam. In the event aperture openings of different size are provided, the beam current can be selected by choosing the desired aperture opening. Further, deflection and correction elements are provided for selecting the beam path through an aperture opening, for aligning the beam and/or for stigmation correcting.

According to embodiments described herein, the emitter has typically a reduced brightness in the range of 1×10⁸-1×10¹² Am⁻²sr⁻¹eV⁻¹. This allows for fast scanning at a sufficient signal to noise ration. The fast scanning is a desire to meet the throughput requirements for the fabrication process. Thereby, the technical term “reduced” means that the brightness is normalized to the energy of the charged particles.

The scanning in the device can be conducted, for example, by two fast scan stages. Thereby, the two stages allow for a sufficiently large scan field of at least 1 μm, for example in the range of 10 μm to 500 μm in one direction. Single stage scan deflection will give slightly reduced scan fields which however are sufficient in many applications. According to further embodiments, which can be combined with any of the embodiments described herein, the scanning speed can typically be provided to be at least 10 MHz pixel frequency, for example in the range of 50 MHz to 3 GHz pixel frequency.

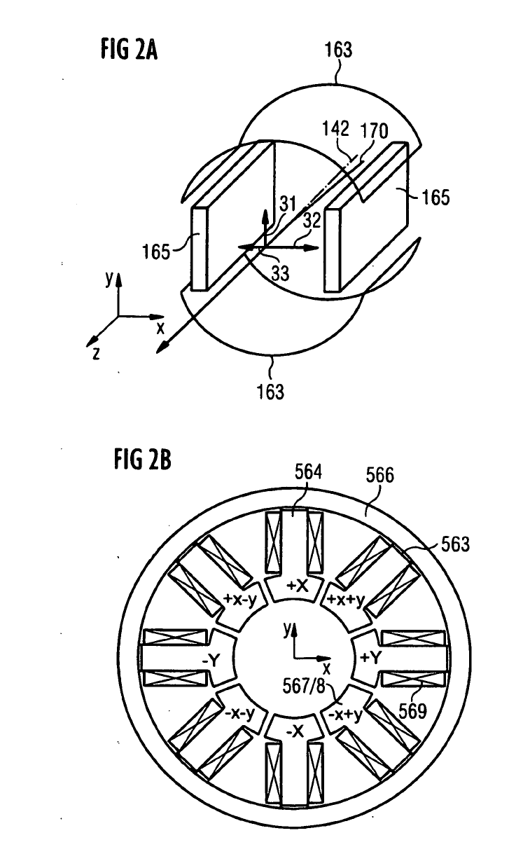

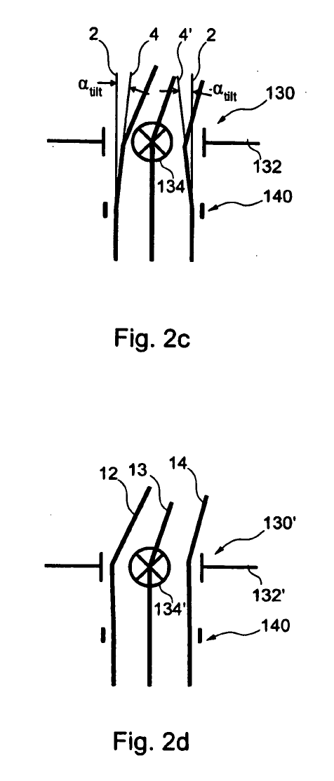

According to embodiments described herein, the first scan stage is provided in front of an achromatic beam separator and the second scan stage is provided after the achromatic beam separator. That is, an achromatic beam separator, typically for separating the primary beam and the signal beam or signal beams, is provided between the first and the second scan stage. The beam separator will be described in more detail with respect to FIGS. 2A to 2C.

According to further additional or alternative implementations of embodiments described herein, the scan stages can be either electrostatic, magnetic, or combined electrostatic-magnetic scan stages.

According to embodiments described herein, the beam scanning electron beam device 100 further includes a lens 150 being an objective lens and focusing the electron beam. The lens 150 can be electrostatic, magnetic or combined electrostatic magnetic. According to some embodiments, which can be combined with other embodiments described herein, the device 100 further includes a shielding electrode 146. This can, for example, be used as a portion of a combined electrostatic-magnetic objective lens, as a portion of elements providing a beam boost (e.g., 2, 5 or 10 times higher energy of the beam in the column between the emitter and the lens), and/or for accelerating the signal electrons.

A scanning electron beam device includes a detection assembly with several detection elements. Generally, the signal electrons are generated on impingement of the primary beam on the specimen 20. The released electrons can be accelerated towards and through the opening in the lens. Further, the signal electrons can typically be secondary electrons, auger electrons, and/or backscattered electrons. The achromatic beam separator 130, which is provided inter alia by a magnetic and an electric field separates the signal electrons from the primary beam.

As shown in FIG. 1, according to some embodiments, which can be combined with any of the embodiments described herein, the signal electrons can be further separated from the primary beam by a double focusing beam bender 160, e.g., in form of a sector. The double focusing bender will be described in more detail below.

As shown in FIG. 1, the detection is provided by a focus lens for focusing the signal electron beam or beams. Thereby, the loss of signal electrons can be reduced. This improves the signal to noise ration which is desired for fast scanning. Further, a small angle detector 178 and a large angle 172 are provided. Between the two detectors an energy filter in the form of biased plates is provided. This arrangement allows an efficient and fast detection of the signal electrons. The amount of information is increased as compared to a system having only one scintillator and a photomultiplier. The increased amount of information again improves fast scanning at a predetermined signal to noise ratio. Accordingly, embodiments described herein, include a multi-channel detection, for example, as described above with respect to FIG. 1.

FIG. 1 shows an example of a high throughput tool. Features of the beam scanning electron beam device 100 can include a high current, high-resolution CFE, fast and large scan by a 2-stage system or a current, high brightness TFE or CFE emitter, fast and large scan by a 2-stage system. A fast multi-perspective detection by a multi-channel detector. Thereby, in order to improved the signal to noise ration for fast detection typically secondary electrons, auger electrons and backscattered electrons can be measured. Accordingly, the detection elements are sensitive to secondary electrons, auger electrons, and for backscattered electrons. According to some embodiments, further an energy and/or angular sensitivity can be provided.

Generally, according to some embodiments, the robustness for operation in semiconductor fabrication processes can be provided by a reduced column size. Accordingly, the length dimensions along the optical axis, i.e. generally the height of the column, can be provided in a range of 100 to 400 mm.

According to yet further embodiments, the emitter, i.e. the gun condenser area, can be provided as follows. According to one embodiment, a single emitter electron gun, typically the TFE source can be used. According to yet further embodiments, the condenser for adjusting the virtual source z-location (z denoting the optical axis) and/or for matching the aperture with the objective lens array can be included. According to yet further alternative or additional modifications, an X-Y stage for the aperture can be provided in order to align the aperture. Typically, it is for example possible to have an electro-magnetic alignment. According to even further additional or alternative modifications the mechanical aperture stage can be provided.

According to yet other embodiments, which can be combined with any of the embodiments described herein, an achromatic deflector 130 or achromatic beam separator 130 having an electrostatic deflection element and the magnetic deflection element can be provided. Within FIG. 1, only the magnetic field is indicated for illustrating the magnetic deflection element. The achromatic deflector 130 deflects the primary electron beam and separates the primary electron beam from the secondary electron beam or beams, i.e., the signal electrons

FIG. 2A shows an enlarged view of the achromatic separator. State of the art electron beam devices mostly use magnetic deflectors or Wien filters for beam separation of primary and secondary beams. Thereby, substantially perpendicular static electric and magnetic fields normal to the z-axis (optical axis) are used. The force acting on the ions is given by the coulomb force

Fₑ=q·E (1)

and the Lorentz force

Fₘ=q·(v×B) (2).

The angle of deflection of the ions in the electric and magnetic fields, both of length l, can be described with the following equation:

θ=ql(vB−E)/(mv²) (3).

FIG. 2A illustrates one embodiment of an achromatic bender or achromatic beam splitter 130. Therein, coil windings 163 and plate-shaped electrodes 165 are shown. The coils 163 generate a magnetic field 31. The magnetic field generates a magnetic force 32 for an electron beam 170. The magnetic force is generated according to equation 2. Substantially perpendicular to the magnetic field 31 an electric field is generated between the electrodes 165. Thereby, an electric force 33, which is substantially opposite to the magnetic force, is generated.

The embodiment shown in FIG. 2A generates perpendicular, uniform magnetic and electric fields. Within FIG. 2A, the electron beam path 170 is slightly inclined with respect to the axis 142 when the electrons enter the achromatic deflector. The electrons are deflected within the achromatic deflector to travel essentially along axis 144 after trespassing the achromatic deflector. This can be understood in light of the derivative of equation 3, that is

dθ/dv=−(qlB/mv²)(1−2E/vB) (4)

The deflection angle is independent of the velocity of the electrons if the condition that the magnetic force equals twice the electric force is fulfilled. In FIG. 2A this is illustrated by the lengths of the force indicating arrows 32 and 33.

In embodiments described herein, the achromatic deflector 162 can be described at least by one of the following features. According to one embodiment, 20 to 80 ampere turns (Aturns), e.g., 40 Aturnes may be provided. According to an even further embodiment, about 10 to 400 coil windings can be provided. Yet according to another embodiment, 50 to 500 coil windings can be provided. Nevertheless, it might be possible to provide even more coil windings, for example, up to a few thousand.

According to an even further embodiment, the achromatic deflection angle can be between 0.3° and 7°. According to another further embodiment, the deflection angle is between 1° and 3°.

The achromatic beam deflector or beam splitter shown in FIG. 2A can be used in accordance with the present invention. Thereby, as described above, electrostatic deflection is given by:

$${α}_{e} ∝ \frac{{E}_{1}}{{U}_{A}} , {U}_{A} \to {U}_{A} + Δ {U}_{A} ⇒ δ α ∝ - Δ {U}_{A}$$

Further, magnetic deflection is given by:

$${α}_{m} ∝ \frac{{B}_{1}}{\sqrt{{U}_{A}}} , {U}_{A} \to {U}_{A} + Δ {U}_{A} ⇒ δ α ∝ - \frac{1}{2} Δ {U}_{A}$$

As described above if the magnetic deflection equals minus two times the electrostatic deflection a deflection without chromatic aberration (dispersion) can be realized.

According to some embodiments described herein, which are illustrated with respect to FIG. 2B, systems including substantially pure dipole fields can be used FIG. 2B shows a system having eight electrodes and pole pieces. Cores 564 are connected to the housing 566 via insulators 563. The coils for exciting the cores and, thereby, the pole pieces are wound around the cores 564. At the other end of the cores, electrode-pole pieces 567/8 are provided. According to embodiments employing a deflection unit as, for example, shown in FIG. 2A, the fringing fields can be provided to be similar for the magnetic field and the electric field; and highly pure dipole fields can be generated. However, the system including eight coils and eight electrodes require more current- and voltage-sources, thereby, costs are increased. As a result, optimized systems having two poles each (electric and magnetic), might typically be used for the embodiments described herein.

Generally, embodiments described herein relate to a high throughput, high-resolution imaging system. The imaging system (beam scanning electron beam device) may include a beam system with a high-performance objective lens with low spherical and chromatic aberration, a low operation beams separator for separating primary and secondary electron beams, and a multi-channel signal detection.

As shown in FIG. 2C, if according to some embodiments the electron beam does not enter the common achromatic beam separator parallel to the optical axis the above described achromatic condition might not be fulfilled for all electron beams. In light of the fact that the first scan stage is provided above the achromatic deflector, there might be a non-neglectable beam tilt, in particular for large scan areas.

FIG. 2C shows three exemplary electron beams entering the achromatic beam separator 130 having an electrostatic deflection element 132 and magnetic deflection elements 134. For ease of reference, the beams are drawn next to each other. Thereby, the center beam is shown to meet the above described achromatic condition. However, the other two electron beams have a tilt angle which is different from the center electron beam and which is indicated with regard to the optical axis 2 of the objective lens assembly 150 and the tilted axis 4 and 4′, respectively. Accordingly, for a tilted electron beam the achromatic beam separator is not perfectly achromatic for all of the electron beams and can thus be denoted as a low aberration beams separator.

According to some embodiments, as shown in FIG. 2C, the tilt correction electron beam optics 140 can be provided in the form of a quadrupole element or the like. Thereby, a correction beam tilt indicated by axis 4 and 4′ of the left electron beam and the right electron beam, respectively, which is not parallel to the center electron beam, and which is deflected achromatically, can be introduced in the tilt correction electron beam optics. The beam tilt −αₜᵢₗₜ and αₜᵢₗₜ, which is introduced for vertical landing and alignment to the objective lens can thereby be introduced. Accordingly, the electron beam passes through the objective lens 150 in parallel after compensating.

According to further embodiments, as shown in FIG. 2D, the achromatic beam separator 130′ having an electrostatic deflection element 132′ and the magnetic deflection element 134′ can be compensated by a superimposed quadrupole field, provided by quadrupole elements, which adjusts the achromatic beam deflection for electron beams that do not pass through the achromatic beam separator 130′ on the center axis. As shown with respect to FIG. 2B, the achromatic beam deflector can be realized by an octupole element. This octupole element allows for an adjusted beam deflection for electron beams that travel through the achromatic beam separator off-axis. Thereby, the electron beams exit the achromatic beam separator along the desired direction, as shown in FIG. 2D, and dispersion of beam tilt deflectors such as element 140 can be avoided.

According to some embodiments, the scanning electron microscope can have a beam bender (see, e.g., 160 in FIG. 1) adapted for having the signal electrons trespassing therethrough. After the primary beams are focused on the specimen, the beam of primary charged particles undergo different interactions with the specimen resulting in secondary particles wherein, the term “secondary particles” is to be understood as including all particles leaving the specimen. Those secondary particle beams can include secondary electrons, auger electrons and backscattered electrons that go through the deflector 130, and which are for example accelerated towards the deflector 130, are deflected towards the beam bender 160.

Generally, beam benders such as bending sectors that might be combined with the embodiments disclosed herein might be electrostatic, magnetic or combined electrostatic-magnetic. Since the space required for an electrostatic bending sector is smaller than the space needed for a sector including a magnetic part, typically an electrostatic sector is used. An electrostatic bending sector may be two electrodes which are shaped roundly. The sector may have a negatively-charged electrode and a positively-charged electrode serving to bend the electron beam. Thereby, the electron beam is focused in one dimension and, additionally, is kept at a high energy to avoid time of flight effects which may have impact on a high-speed detection. A focusing in the second dimension can take place in a quadrupole element, by an electrostatic side plate or a cylinder lens. Thereby, a double-focusing bender, e.g. in the form of a double-focusing sector unit can be provided.

Thereby, the beam of secondary charged particles can be deflected by about 90° with respect to the beam of primary charged particles. However, other values between 30° and 110°, typically between 45° and 95° or between 60° and 85°, are also possible. Additional to the deflection, the beam is typically also focused, as described above already. One advantage of applying a bending sector is that the beam of secondary charged particles is guided away from the direct vicinity of the primary charged particle beam. Thus, analysis tools can be applied in the charged particle beam device without the need to fit them into the limited space nearby the primary charged particle beam and furthermore, without leading to undesirable interactions with the primary charged particle beam.

Instead of the electrodes, which may optionally be provided with additional side plates, the bending sector can be a hemispherical sector. The hemispherical sector allows for the two-dimensional focusing of the beam. Thus, no additional focusing unit is required for a double focusing sector unit. Generally, an electrostatic beam bending sector can be either cylindrical or hemispherical. The cylindrical type suffers from the fact that as the beam is bent the secondary electrons are focused in one plane and not in the other. A hemispherical bending sector focuses the secondary beam in both planes. The cylindrical sector can be used with side plates biased to achieve focusing in the transverse plane, yielding similar focusing properties to the hemispherical sector.

A model of an achromatic beam separation or beam deflector, which may also be used as an embodiment, which can be combined with other embodiments described herein, can be described as follows. Saddle coils having an inner diameter of 36 mm and a 2 mm×2 millimeter X-section, as well as 40 ampere turns, may further have a length of about 30 mm. A 60° angle of the saddle coils can reduce or avoid hexapole components. Further, alternatively, a combination of coils with a 42° and 78° angle can reduce or avoid hexapole and decapole components. The electrostatic deflector, i.e. the electrodes shown in FIG. 2B, may have an optical geometry of an inner diameter of 16 mm and a length of 30 mm. Further, a +−500 V deflection voltage (static) floating on a column voltage can be provided. If, as described with respect to FIG. 2B, x,y,=0.7071·X,Y, hexapole and decapole components may be reduced or avoided. For the model, the column voltage is given as 9.5 keV, that is the, voltage can in general be set on increased potential (e.g., 5 times, 10 times or even 20 times increase) for providing the beam boost within the column, and the landing energy is 500 eV or 1 keV, respectively.

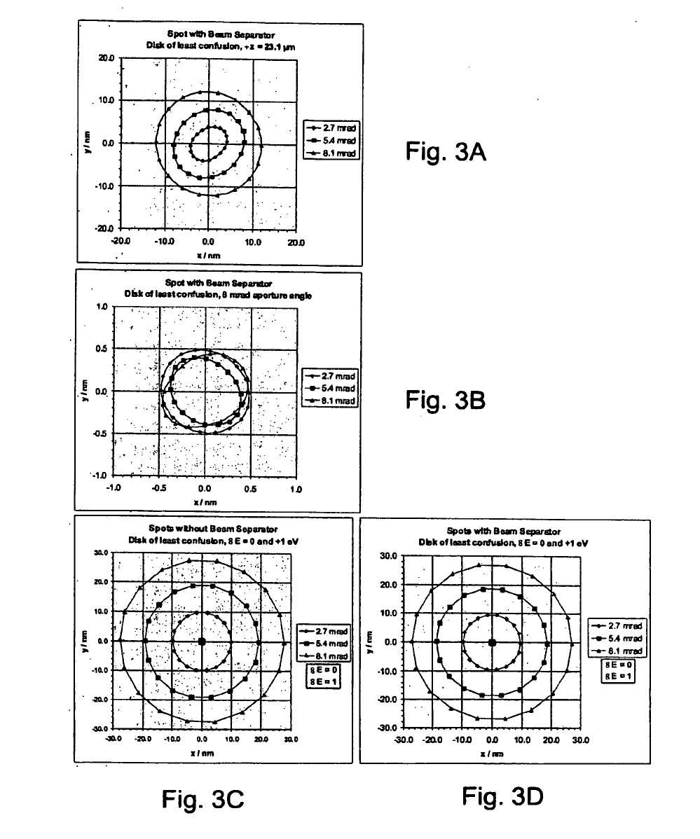

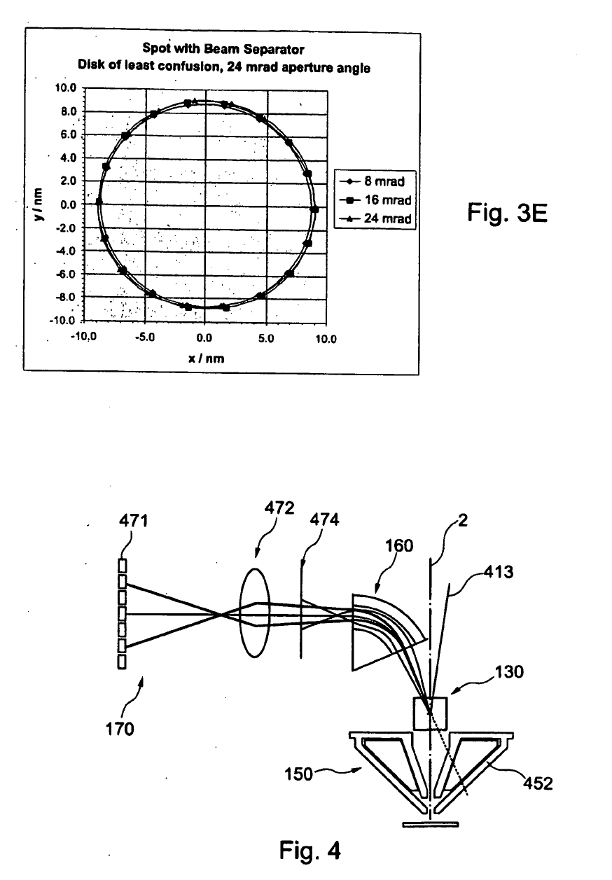

FIG. 3A presents a simulation result of the beam separator. The deflection causes some astigmatism. However, the astigmatism is small enough to be corrected. The corrected astigmatism is shown in FIG. 3B. Thereby, the spot diameter can be reduced from 24 nm in FIG. 3A to about 1 nm in FIG. 3B. FIGS. 3C and 3D further show that the achromatic beam separator or achromatic beam deflector, which has been described above, does not introduce additional chromatic aberrations. Thereby, FIG. 3C shows the spots without the beam separator, wherein FIG. 3D shows the spots with a beam separator. In the FIGS. 3C and 3D no substantial difference can be seen. FIG. 3E shows a further simulation of the beam separator showing large beam X-sections with a 60° saddle coil. As can be seen in FIG. 3E, no significant additional aberrations, for example “hexapole” coma, are introduced. Accordingly, a 60° saddle coil with large diameter can be considered sufficient for embodiments of an achromatic or low aberration beam separator as described herein.

As can be shown by simulations, the achromatic beam deflector is also not very sensitive to energy changes of the landing energy on the specimen. Thus, the tolerance with respect to the change of energy can be reduced for smaller deflections. The deflector does not need to be readjusted for small energy variations.

Further alternative or additional implementations with regard to the detection that might for example include a spectrometer, will now be described. Thereby, reference will partly be made to FIG. 4. Generally, the achromatic beam separator might be considered achromatic for the primary electron beams but may introduce dispersion for the secondary signal beams. For easier understanding, FIG. 4 shows only one primary and one signal beam. However, the same principle can be used for a plurality of signal beams.

The achromatic beam deflector separates the signal beam from the primary beam and introduces a dispersion as indicated by the three different beams. After trespassing through the beam bender, e.g., in form of a sector, the dispersion can be seen in the plane of a dispersive image indicated by reference numeral 474. The lens 472 images the different virtual images corresponding to different signal beam energies on the sub-detection elements 471. Thereby, energy filtering can be realized.

The beam ray of the center beam is indicated in FIG. 4. As can be seen there is a crossover shortly after the bending sector 160. Generally, according to other embodiments, the sub-detection elements may also be positioned directly after the bender 160, typically in the focus of the different signal beams having different signal energies. However, the lens 472 allows for imaging and magnification of the energy spread. Accordingly, a fast and parallel detection of different ΔE channels can be realized. This might for example be used for element mapping or potential mapping, e.g., for dopant profiles.

As describe above, the achromatic beam separator and/or the beam bender separate the signal electrons and the primary electrons. Generally, the mechanical configuration of the detection system can simplified by the separation. As described, the detection can be improved by a separation of the primary and the secondary beam arrays. In this case, a beam separator based on a magnetic field or a combined electrostatic-magnetic field can separate the secondary beam array from the path of the primary beam array. According to some embodiments described herein, an achromatic beam separator as discussed e.g. with respect to FIGS. 2A-2D and can be used. The “complete” separation simplifies design of the detector and allows easier integration of elements for an energetic and/or annular discrimination such as, for example energy filters and spectrometers, and/or elements for annular multi-perspective detection. According to further additional or alternative implementations, the detection system may contain sector field-based spectrometers, a retarding field spectrometer, lenses for annular control, deflectors for alignment and selection and the like. Thereby, according to typical embodiments described herein, a separation, filtering, alignment, annular control is provided.

According to further alternative or additional implementations, the double focusing bending element, such as a bending sector, typically a spherical electrostatic sector arrangement is provided. Typically, the beam detectors can be positioned close to the focus of the sector in order to avoid cross-talk between beams of e.g. different. In order to improve the space requirements, a scintillation detector with a photomultiplier (PMT) and, for example, a light guide in between is provided for the beam. Thereby, sufficient space for a PMT-array can be realized. According to yet further embodiments, which can be combined with other embodiments described herein, mechanical and/or electromagnetic alignment for the signal electrons on the detector or the detector channels can be provided. In light of the parallel detection of a plurality of channels, it is further possible to have individual detection electronics for each channel.

According to some embodiments which can be combined with other embodiments described herein, the systems for providing a high throughput tool may typically be a low-voltage system, i.e. having low beam energy on the specimen. This energy may for example be in the range of 100 eV to 5 keV. Typically it is possible for low-voltage beam energies to have the electrons traveling within the column on a high beam energy, for example 8 to 10 keV or 7-15 keV. This beam boost principle can reduce the electron-electron interaction within the column in light of the shorter flight. According to even further alternative or additional implementations, the column components can be at ground potential whereas the emitter and the wafer are at a high potential. Thereby, the scan module, the beam separator and the bender can be at ground potential. This simplifies in particular the common electron beam optical elements.

According to some embodiments, which can be combined with other embodiments described herein, a high brightness source emitter with large angular emission can be used to realize high probe currents. For example, thermal field emission cathodes such as TFE with large emitter curvature radii (e.g. 0.5 μm or larger or even 1 μm or larger) can be used. According to other embodiments, CFE, Schottky emitters, and the like can be used.

According to yet further embodiments, which can be combined with other embodiments described herein, the system specifications can include a probe current at the sample in a range of 10 pA to 10 nA, for example 100 pA to 1 nA. Further, spot diameters used for systems described herein may be in the range of 1 nm to 50 nm, typically 1 nm to 20 nm.

Further options for systems described herein may include an achromatic beam separator with a superimposed electro-magnetic quadrupole, which might for example be generated by the octupole element shown in FIG. 2B. This quadrupole may influence tilted primary beams (in one direction) in such a way that the beam will exit the objective lens array with vertical incidents. Thereby, as described with respect to FIG. 2D, no individual beam tilt might be required if non-parallel beamlets are used in an achromatic beam separator. Thereby, chromatic aberrations for the beams can be reduced and, accordingly, the spot size and, thus, the resolution of off-axis beamlets can be improved.

Embodiments described herein also refer to methods to superimpose an electrostatic-magnetic quadrupole to an achromatic beam separator (electrostatic-magnetic dipole. The quadrupole can be aligned to the overall system optical axis, whereby off-axis beamlets will be tilted (in one direction) for vertical entrance into a subsequent optical element.

According to yet further embodiments, which can be combined with other embodiments described herein, electron beam inspection with high throughput and small probe diameter can be provided as follows. Generally, providing a high throughput, high resolution (small electron beam probe on the specimen) inspection device requires improved detection assemblies and low dispersion as described above. Thereby, a beam separation simplifies improved detection assemblies. Further, the increasing resolution requirements make low dispersion systems with low electron-electron interaction in the column desirable. The electron-electron interaction can, for example, be reduced by avoiding a cross-over of the beam and/or shortening the column length. Common beam separators use magnetic, electrostatic deflectors or Wien filters. The dispersion of these systems may not be avoided unless a cross-over is positioned in the center of the separation element. This may, however, reduces the flexibility of the optical ray path and increases the energy width (Boersch effect/electron-electron interaction). As an alternative a double stage Wien filter or additional components for symmetrical deflection might be used for decreasing dispersion effects. However, this increases the optical path length of the column and accordingly the spot size by electron-electron interaction. These limitations might be avoided by using an achromatic element as a beam separator.

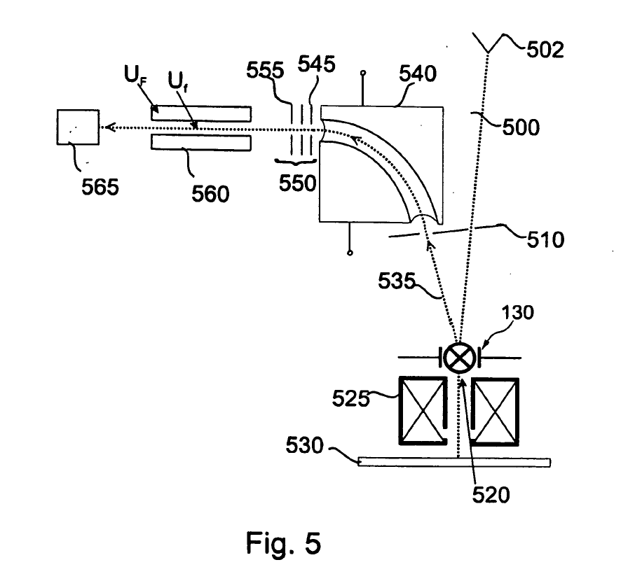

FIG. 5 shows a view of an optical system having an achromatic beam separator as described above and a hemispherical sector in accordance with an embodiment of the invention. Side plates are not required in this embodiment since the hemispherical sector provides focusing of the secondary electron beam in both planes.

Referring to FIG. 5, a primary-electron beam 500 passes through an opening in a plate 510 and is bent (changes direction) as it passes through the achromatic beam separator 130. As one example, the plate 510 can be part of a beam boost system, which sets the beam energy to a higher potential in the column, as described above. Primary-electron beam 500 continues through an opening 520 in objective lens 525 to strike a sample such as semiconductor wafer 530. The resulting secondary-electron beam 535 passes through opening 520 in objective lens 525 and is bent (changes direction) as it passes through achromatic beam separator. After passing through an opening in plate 510, secondary-electron beam 535 enters a hemispherical sector 540.

Following the sector is a set of focusing and filtering elements to focus the secondary electron beam to a small (e.g., 4 mm diameter) spot on the active area of electron detector 565 and to enable energy filtering of the secondary electron beam. Focusing can be done either with magnetic lenses or electrostatic lenses. Electrostatic lenses offer a more compact size and reduced complexity. Filtering requires one or more electrostatic electrodes since one must change the energy of the secondary beam.

In the embodiment of FIG. 5, the focus lens is a simple electrostatic lens consisting of three electrodes forming the lens 550. SE alignment means can be incorporated e.g. by designing electrodes 545 and/or 555 as quadrupoles. Secondary-electron filter 560 is a long cylinder which is biased approximately to the same potential as the sample wafer

Lens 550 can be an immersion lens or an Einzel lens. In the event the wafer is biased the plates 545, 555 may be grounded.

Within the above-described embodiment, the quadrupole 545 and the plate 555 are integrated in the lens 550. Generally, with regard to all embodiments shown in this application, it is possible that the quadrupole and/or the plate are provided independently of the lens. Thereby, an appropriate number of lens electrodes is provided and additionally the electrodes of the quadrupole 545 and the plate 555 are provided. Further, it is possible that instead of the plate 555 a quadrupole is provided. This second quadrupole would allow for additional alignment of the secondary electron beam.

Generally, a lens focusing the secondary electron beam is positioned between the separating unit (achromatic beam separator) and the detector. Typically, it is positioned between the deflection angle increasing unit (separating unit) and the filter. The focusing lens can either be electrostatic (see above-mentioned Einzel-lens), magnetic or combined electrostatic-magnetic. Typically, for space reasons an electrostatic lens will be used for focusing the secondary electrons. Further, it is possible to provide an Einzel lens or an immersion lens as focusing unit for the secondary electron beam.

Focusing the secondary-electron beam 535 to a small spot on the detector enables high-speed imaging. The detector type is, for example, a p-i-n diode. Such detectors are excellent for high-current electron-beam systems since they have very high quantum efficiency (nearly equal to one) and excellent response time if they are small. Response time is proportional to capacitance of the device and capacitance is proportional to area. Thus, the area should be minimized. Therefore, however, a focusing of the secondary electron beam is advantageous. Typically, a detector active area of 4-5 mm diameter is suitable for imaging rates in the vicinity of 600 MPPS.

Even though this embodiment has been described including a pin-diode, other detectors may be used. For all embodiments disclosed herein, a fast scintillation detector may be used or a pin-diode may be used. The detector is typically arranged behind the deflection angle increasing unit, that is, for example the sector in the above-described figure. In case of a scintillation detector the secondary electron beam will typically not be focused on the detector. Thereby, it's life time is increased and contamination is reduced.

For normal imaging modes (non voltage contrast) the goal of the focusing elements is to produce a small spot on the detector. In this mode both the filter and focus electrodes can be employed for SE beam focusing.

In voltage contrast mode the filter electrode 560 acts as a high-pass filter, rejecting secondary electrons that are below a set (user selectable) initial energy level at the plane of wafer 530. The secondary electrons exit the sector 540 and are focused through a decelerating electrostatic lens (SE focus lens) such that a crossover is formed inside the filter electrode field. The filter electrode 560 is biased to a potential U_{F} producing a saddle potential U_{f}. These potentials are generally relative potentials with respect to the wafer. Therefore, electrons released from the specimen with a potential above U_{f} can pass the filter, whereas electrons with a potential below (or equal) U_{f} can not pass the filter and are rejected.

A typical application for voltage contrast imaging is unfilled or filled contact holes in devices on a wafer. This layer of the device to be inspected consists of a field of dielectric material with isolated conductive contacts that have a path to either the bulk silicon or a large capacitance metal layer below the contact. One voltage contrast technique that has shown to be successful in electron-beam inspection is to charge the dielectric material positively with the electron beam to a value in the range of 5-50V. Secondary electrons that emit from the charged dielectric must therefore have an initial energy greater than the surface charge potential to escape and contribute to the detector signal. Secondary electrons that are emitted from the good contacts are essentially emitted from a grounded substrate and have the typical secondary energy distribution associated with grounded metal materials with a peak near 2 eV. If one were then to filter the secondary signal such that all electrons having an initial energy greater than (for example) 5 eV are detected, the regions in the image representative of the charged dielectric would appear dark and the good contacts would appear bright.

Generally, the embodiments described herein can be used to provide an array of corresponding systems. Thus, for example, several assemblies including a first scan stage for scanning the beam over a specimen, an achromatic beam separator adapted for separating a signal electron beam from the primary electron beam, and a detection unit for detecting signal electrons can be provided next to each other in order to further increase the throughput by providing a corresponding inspection, testing or imaging system two or more times. These assemblies can be provided adjacent to each other in form of an array, or, typically along one dimension. Accordingly, a multi-beam module or a multi-column module can be provided.

In light of the above, some embodiments provide a scanning charged particle beam device. The device includes a beam emitter for emitting a primary electron beam, a first scan stage for scanning the beam over a specimen, an achromatic beam separator adapted for separating a signal electron beam from the primary electron beam, and a detection unit for detecting signal electrons. According to optional implementations, the device can include a second scan stage for scanning the beam over the specimen, for example, such that the achromatic beam separator is positioned between the first scan stage and the second scan stage, and wherein the detection unit is a multi-channel detection unit. According to other additional or alternative implementations, a double focusing beam bender, in particular a hemispherical sector can be provided, means for superimposing quadrupole field over the fields of the achromatic beam separator can be provided, the multi-channel detection unit can include an energy filter, the multi-channel detection unit can include a detector for a first (large) angle and a detector for an second angle being smaller than the first angle, and/or the multi-channel detection unit can be adapted for detecting secondary electrons, auger electrons, and backscattered electrons.

According to yet other further embodiments, which can be combined with other embodiments described herein, the multi-channel detection unit can have two or more detection sub-elements and means for guiding signal electrons having different energies to different detection sub-elements, the device can have an optical length of about 300 mm or less between the emitter and the sample, the beam emitter can be adapted for providing a reduced brightness of at least at least 1×108 Am-2sr-1eV-1, in particular in the range of 1×108-1×1012 Am-2sr-1eV-1, the first and/or the second scan stage can be adapted for scanning with a scanning velocity of at least 10 MHz pixel frequency, in particular in the range of 50 MHz to 3 GHz pixel frequency, the achromatic beam separator can be provided at a beam path position without a cross-over, the achromatic beam separator can be provided at a beam path position, wherein the primary electron beam is inclined by a first angle with respect to an optical axis defined by an objective lens, and/or the beam emitter can emit the primary electron beam at the first angle with respect to the optical axis defined by an objective lens.

According to other embodiments, an array or one or two lines of devices can be provided to further increase the throughput. Thereby a device includes at least one further beam emitter for emitting a primary electron beam, at least one further first scan stage for scanning the beam over a specimen, at least one further achromatic beam separator adapted for separating a signal electron beam from the primary electron beam, and at least one further detection unit for detecting signal electrons. It is also possible that a scanning charged particle beam device assembly including two or more devices according to any of the embodiments described herein is provided.

According to yet other embodiments, a method of operating an achromatic beam deflector for charged particle beams can be provided. The achromatic beam deflector having an optical axis. The method includes providing a deflecting electrostatic dipole field, providing a deflecting magnetic dipole field, superimposing a quadrupole field to the magnetic dipole field and the electrostatic dipole field, wherein the electrostatic dipole field and the magnetic dipole field are adjusted with respect to each other to provide an achromatic beam deflection, and wherein the quadrupole field is adjusted to correct for a beam tilt of off-axis charged particle beams. According to typical implementations, the charged particle beam can be deflected for an angle of between 0.3° and 7°, the quadrupole field can be aligned to the optical axis of the achromatic beam deflector, an off-axis beam of a multi-beam array can be corrected and/or a correction can be done along one direction.

While the foregoing is directed to embodiments of the invention, other and further embodiments of the invention may be devised without departing from the basic scope thereof, and the scope thereof is determined by the claims that follow.

1. A scanning charged particle beam device, comprising:
a beam emitter for emitting a primary electron beam;
a first scan stage for scanning the beam over a specimen;
an achromatic beam separator adapted for separating a signal electron beam from the primary electron beam; and
a detection unit for detecting signal electrons.

2. The scanning charged particle beam device according to claim 1, further comprising:
a second scan stage for scanning the beam over the specimen.

3. The scanning charged particle beam device according to claim 2, wherein the achromatic beam separator is positioned between the first scan stage and the second scan stage, and wherein the detection unit is a multi-channel detection unit.

4. The scanning charged particle beam device according to any of claim 1 or 3, further comprising:
a double focusing beam bender, in particular a hemispherical sector.

5. The scanning charged particle beam device according to any of claims 1 to 4, further comprising:
means for superimposing quadrupole field over the fields of the achromatic beam separator.

6. The scanning charged particle beam device according to any of claims 1 to 5, wherein the multi-channel detection unit includes an energy filter.

7. The scanning charged particle beam device according to any of claims 1 to 6, wherein the multi-channel detection unit includes a detector for a first (large) angle and a detector for an second angle being smaller than the first angle.

8. The scanning charged particle beam device according to any of claims 1 to 7, wherein the multi-channel detection unit is adapted for detecting secondary electrons, auger electrons, and backscattered electrons.

9. The scanning charged particle beam device according to any of claims 1 to 8, wherein the multi-channel detection unit has two or more detection sub-elements and means for guiding signal electrons having different energies to different detection sub-elements.

10. The scanning charged particle beam device according to any of claims 1 to 9, wherein the device should have an optical length of about 300 mm or less between the emitter and the sample.

11. The scanning charged particle beam device according to any of claims 1 to 10, wherein the beam emitter is adapted for providing a reduced brightness of at least at least 1×10⁸ Am⁻²sr⁻¹eV⁻¹, in particular in the range of 1×10⁸-1×10¹² Am⁻²sr⁻¹ eV⁻¹.

12. The scanning charged particle beam device according to any of claims 2 to 11, wherein first and/or the second scan stage is adapted for scanning with a scanning velocity of at least 10 MHz pixel frequency, in particular in the range of 50 MHz to 3 GHz pixel frequency.

13. The scanning charged particle beam device according to any of claims 1 to 12, wherein the achromatic beam separator is provided at a beam path position without a cross-over.

14. The scanning charged particle beam device according to any of claims 1 to 13, wherein the achromatic beam separator is provided at a beam path position, wherein the primary electron beam is inclined by a first angle with respect to an optical axis defined by an objective lens.

15. The scanning charged particle beam device according to claim 14, wherein the beam emitter emits the primary electron beam at the first angle with respect to the optical axis defined by an objective lens.

16. The scanning charged particle beam device according to any of claims 1 to 15, wherein the device includes at least one further beam emitter for emitting a primary electron beam, at least one further first scan stage for scanning the beam over a specimen, at least one further achromatic beam separator adapted for separating a signal electron beam from the primary electron beam, and at least one further detection unit for detecting signal electrons.

17. A scanning charged particle beam device assembly comprising:
at least two scanning particle beam devices according to any of claims 1 to 15.

18. The scanning charged particle beam device assembly according to claim 17, wherein the at least two devices are arranged along one or two lines.

19. Method of operating an achromatic beam deflector for charged particle beams, the achromatic beam deflector having an optical axis, comprising:
providing a deflecting electrostatic dipole field;
providing a deflecting magnetic dipole field;
superimposing a quadrupole field to the magnetic dipole field and the electrostatic dipole field;
wherein the electrostatic dipole field and the magnetic dipole field are adjusted with respect to each other to provide an achromatic beam deflection, and
wherein the quadrupole field is adjusted to correct for a beam tilt of off-axis charged particle beams.

20. The method according to claim 20, wherein the charged particle beam is deflected for an angle of between 0.3° and 7°.

21. The method according to any of claims 19 to 20, wherein the quadrupole field is aligned to the optical axis of the achromatic beam deflector.
